(19) United States
(12) Patent Application Publication
(10) Pub. No.: US 2026/0358624 A1
(43) Pub. Date: Nov. 12, 2026

(54) IMAGE PICKUP DEVICE

(71) Applicant: Murata Manufacturing Co., Ltd., Nagaokakyo-shi (JP)

(72) Inventors: Yuuki ISHII, Nagaokakyo-shi (JP); Hitoshi SAKAGUCHI, Nagaokakyo-shi (JP); Noritaka KISHI, Nagaokakyo-shi (JP); Yuka TANAKA, Nagaokakyo-shi (JP)

(21) Appl. No.: 19/716,718

(22) Filed: Jun. 23, 2026

Related U.S. Application Data
(63) Continuation of application No. PCT/JP2024/034115, filed on Sep. 25, 2024.

(30) Foreign Application Priority Data
Jan. 12, 2024 (JP) 2024-003242

(51) Int. Cl. G02B 27/00; G03B 5/00; G03B 17/08; G03B 17/12; G03B 17/55; G03B 30/00; H04N 23/52; H04N 23/54

(52) U.S. Cl. CPC G02B 27/0006; G03B 5/00; G03B 17/08; G03B 17/12; G03B 17/55; H04N 23/52; H04N 23/54; G03B 30/00; G03B 2205/0061; G03B 2217/002

(57) ABSTRACT

An image pickup device that includes: a light-transparent body that transmits light with a predetermined wavelength; a first tubular housing, and that holds the light-transparent body; a vibrator that disposed in the first housing, and configured to vibrate the light-transparent body; a piezoelectric device disposed at the vibrator, and configured to vibrate the vibrator; and a second housing directly connected by welding to a first side of the first housing opposite a second side thereof at which the first housing holds the light-transparent body.

### CROSS REFERENCE TO RELATED APPLICATIONS

The present application is a continuation of International application No. PCT/JP2024/034115, filed Sep. 25, 2024, which claims priority to Japanese Patent Application No. 2024-003242, filed Jan. 12, 2024, the entire contents of each of which are incorporated herein by reference.

### TECHNICAL FIELD

The present disclosure relates to an image pickup device.

### BACKGROUND ART

Some vehicles include an image pickup device installed at the front or rear of the vehicle to control a safety device or provide driving support using images obtained by the image pickup device. Such an image pickup device is typically disposed outside the vehicle. Thus, foreign matter such as raindrops (water droplets), mud, or dust may adhere to a light-transparent body (a protective cover or a lens) covering the exterior of the image pickup device.

When foreign matter adheres to the light-transparent body, the image pickup device captures an image that includes the foreign matter, and thus fails to obtain a clear image. An image pickup device described in International Publication No. 2023/127197 (Patent Document 1) includes a vibrating device that vibrates a light-transparent body to remove foreign matter adhering to the surface of the light-transparent body.

Patent Document 1: International Publication No. 2023/127197

### SUMMARY OF THE DISCLOSURE

The vibrating device in the image pickup device described in Patent Document 1 includes a combination of an outermost-layer lens (light-transparent body), a vibrator, a piezoelectric device, and a fixing portion.

However, the image pickup device described in Patent Document 1 increases the mass of the fixing portion to reduce leakage of vibrations from the vibrator, thereby increasing the size of the fixing portion.

The present disclosure aims to provide an image pickup device capable of reducing leakage of vibrations from a vibrator without increasing the size of a fixing portion.

An image pickup device according to an aspect of the present disclosure includes: a light-transparent body that transmits light with a predetermined wavelength; a first tubular housing, and that holds the light-transparent body; a vibrator that disposed in the first housing, and configured to vibrate the light-transparent body; a piezoelectric device disposed at the vibrator, and configured to vibrate the vibrator; and a second housing directly connected by welding to a first side of the first housing opposite a second side thereof at which the first housing holds the light-transparent body.

According to the present disclosure, the second housing is directly connected by welding to a side of the first housing opposite a side at which the first housing holds the light-transparent body. Thus, the image pickup device according to the present disclosure can reduce leakage of vibrations from the vibrator without increasing the size of the first housing (fixing portion).

### BRIEF DESCRIPTION OF THE DRAWINGS

FIG. 1 is a perspective view of an image pickup device according to an embodiment.

FIG. 2 is a cross-sectional view of an image pickup device according to an embodiment.

FIG. 3 is a diagram describing an example of connection between a fixing portion and a holding member in an inner-layer lens.

FIG. 4 is a cross-sectional view of an image pickup device according to a first modification example.

FIG. 5 is a cross-sectional view of an image pickup device according to a second modification example.

FIG. 6 is a cross-sectional view of an image pickup device according to a third modification example.

### DESCRIPTION OF THE PREFERRED EMBODIMENTS

With reference to the drawings, an image pickup device according to the present disclosure is described below in detail. Throughout the drawings, the same reference signs denote the same or corresponding components. The image pickup device described below is usable as, for example, a vehicle-mounted image pickup device, and can vibrate a light-transparent body (such as an outermost-layer lens) to remove foreign matter adhering to the surface of the light-transparent body. The purpose of the image pickup device is not limited to use as a vehicle-mounted image pickup device. For example, the image pickup device is also applicable to a surveillance camera for security purposes, or an image pickup device mounted on a drone.

### Embodiments

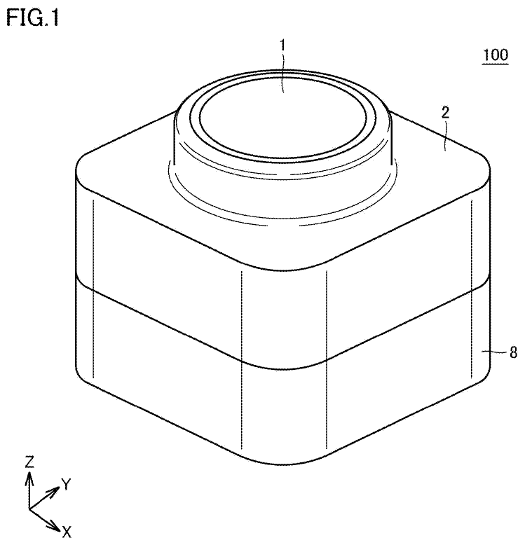

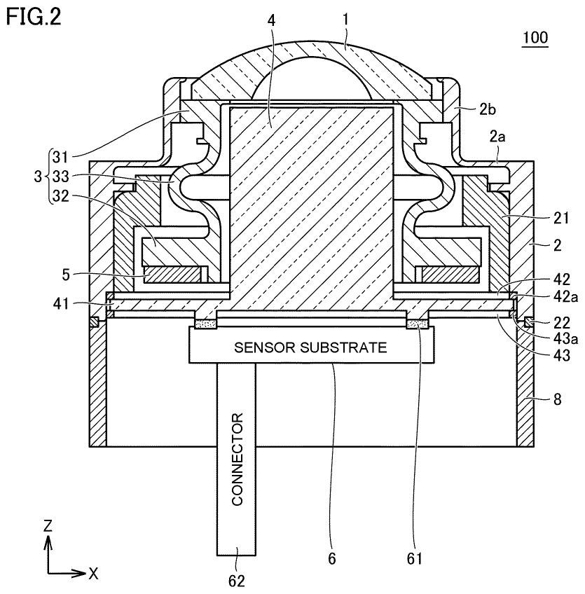

FIG. 1 is a perspective view of an image pickup device 100 according to an embodiment. FIG. 2 is a cross-sectional view of the image pickup device 100 according to an embodiment. An X-direction, a Y-direction, and a Z-direction in the drawings respectively denote the lateral direction, the depth direction, and the height direction of the image pickup device 100. The image pickup device 100 includes a fixing portion 2 (first housing) that holds an outermost-layer lens 1, and a housing 8 (second housing) directly connected to the fixing portion by welding. On the inner side of the fixing portion 2, a vibrator 3, an inner-layer lens 4, and a piezoelectric device 5 are disposed. On the inner side of the housing 8, a sensor substrate 6 (first substrate) on which an image pickup element (not illustrated) is mounted is disposed. The image pickup element is disposed on the sensor substrate 6 with the outermost-layer lens 1 and the inner-layer lens 4 in a direction of a field of view.

After the alignment between the outermost-layer lens 1 and the inner-layer lens 4 is adjusted, a holding member 41 in the inner-layer lens 4 is fixed to the fixing portion 2. After the alignment between the inner-layer lens 4 and the image pickup element is adjusted, the sensor substrate 6 is fixed with an adhesive to the holding member 41 of the inner-layer lens 4 at a surface facing the holding member 41. When the sensor substrate 6 and the holding member 41 of the inner-layer lens 4 are fixed with an adhesive, the alignment of the sensor substrate 6 with respect to the inner-layer lens 4 can be adjusted in six axes, and the optical characteristics can be stabilized. The adhesive also functions as a buffer member between the sensor substrate 6 and the holding member 41 of the inner-layer lens 4, and can reduce leakage of vibrations to the sensor substrate 6. The adhesive can thus stabilize the optical characteristics and reduce damping of the vibrator 3.

The image pickup element mounted on the sensor substrate 6 is an image sensor such as a charge-coupled device (CCD) or a complementary metal-oxide-semiconductor (CMOS) sensor. The sensor substrate 6 includes a semiconductor device that controls the image pickup element, such as a general-purpose integrated circuit (IC) or an application-specific integrated circuit (ASIC). The sensor substrate 6 includes a connector 62. Through the connector 62, the sensor substrate 6 performs signal input or output with an external device or receives power from an external power supply.

The inner-layer lens 4 (inner lens) has a structure in which multiple lenses are held by the holding member 41 (inner-layer lens barrel). In the drawing of the present disclosure, multiple lenses in the inner-layer lens 4 are illustrated as an integrated unit. The multiple lenses included in the inner-layer lens 4 are held by the holding member 41 while being aligned, and thus do not need to be individually aligned again when being mounted on the image pickup device 100.

The outermost-layer lens 1 is a light-transparent body that transmits light of a predetermined wavelength (for example, a wavelength of visible light or a wavelength capturable by an image pickup element), for example, borosilicate-crown glass (BK7), fused quartz, crown glass, flint glass, or a convex meniscus lens. The image pickup device 100 may include a transparent member such as a protective cover instead of the outermost-layer lens 1. The protective cover is formed from glass or resin such as transparent plastics.

An end portion of the outermost-layer lens 1 is held at an end portion of a leaf spring 2a extending from the fixing portion 2. A space between the outermost-layer lens 1 and a retainer 2b positioned at the end portion of the leaf spring 2a is filled with an adhesive. The fixing portion 2 is formed from, for example, aluminum (for example, A5052).

The image pickup device 100 further includes the vibrator 3 to vibrate the outermost-layer lens 1 held by the fixing portion 2. The vibrator 3 is formed from, for example, stainless steel (SUS304, SUS420, or SUS440).

As illustrated in FIG. 2, the vibrator 3 has a tubular body, and includes a connection portion 31 (first portion) that is in contact with the outermost-layer lens 1, a vibrating portion 32 (second portion) at which the piezoelectric device 5 is disposed, and a support portion 33 (third portion) that connects the connection portion 31 and the vibrating portion 32. The support portion 33 has an S-shaped cross section. As illustrated in FIG. 2, the inner-layer lens 4 is disposed in the tube of the vibrator 3.

The connection portion 31 has a cylindrical shape extending in the axial direction (Z-direction) of the tubular body, and the end portion extends in the radial direction (X- and Y-directions) of the tubular body. Thus, the end portion of the connection portion 31 can stably come into contact with the edge portion of the outermost-layer lens 1. The connection portion 31 may simply include a portion extending in the axial direction (Z-direction) of the tubular body or a portion extending in the radial direction (X- and Y-directions) of the tubular body.

The vibrating portion 32 is a portion that vibrates together with the vibrations of the piezoelectric device 5, and has a larger thickness than the connection portion 31 and the support portion 33. This structure can more efficiently transmit the vibrations of the piezoelectric device 5 to the outermost-layer lens 1.

The support portion 33 is a portion that supports the connection portion 31 and transmits the vibrations of the vibrating portion 32 to the connection portion 31. The connection portion 31, the vibrating portion 32, and the support portion 33 may be formed integrally with or separately from one another.

The piezoelectric device 5 is disposed at a surface of the vibrating portion 32 away from a surface that is in contact with the outermost-layer lens 1. The piezoelectric device 5 is hollow, and vibrates, for example, when being polarized in a thickness direction. The piezoelectric device 5 is formed from lead zirconate titanate (PZT) piezoelectric ceramics. Alternatively, other piezoelectric ceramics such as (K, Na) NbO₃ piezoelectric ceramics may be used. Alternatively, piezoelectric single crystals such as LiTaO₃ may be used.

When the hollow circular piezoelectric device 5 vibrates in the radial direction, and the vibrations are transformed by the support portion 33 of the vibrator 3 into the vibrations in the Z-direction (vertical direction in the drawing), the outermost-layer lens 1 vibrates in the Z-direction.

The vibrator 3 displaces the outermost-layer lens 1 in the Z-direction by elastically deforming the support portion 33 like a spring. With the vibrations of the vibrator 3, the leaf spring 2a of the fixing portion 2 that holds the outermost-layer lens 1 is also elastically deformed. With the vibrations of the vibrator 3, the outermost-layer lens 1 is displaced at the maximum, whereas a center portion of the portion of the support portion 33 having an S-shaped cross section is displaced to a lesser extent.

A large portion of the vibrations of the outermost-layer lens 1 is absorbed by the elastic deformation of the leaf spring 2a, but the vibrations that remain unabsorbed are transmitted to the fixing portion 2, causing the fixing portion 2 to vibrate. The vibrations of the fixing portion 2 constitute leakage of vibrations from the vibrator 3. To reduce the leakage of vibrations, increasing the mass of the fixing portion 2 is a conceivable method. However, increasing the mass of the fixing portion 2 involves increasing the size of the fixing portion 2.

Thus, in the image pickup device 100 according to the present embodiment, the housing 8 is directly connected to the fixing portion 2 by welding instead of increasing the mass of the fixing portion 2. More specifically, the housing 8 is connected to the fixing portion 2 to add the mass of the housing 8 to the mass of the fixing portion 2, thereby increasing the total mass and reducing leakage of vibrations from the vibrator 3. As compared to the case in which the fixing portion 2 and the housing 8 are connected by screwing, when the fixing portion 2 and the housing 8 are directly connected with a welding portion 22, noise caused by friction of vibration at the contact portion between components can be reduced. When the fixing portion 2 and the housing 8 are directly connected by welding, waterproofness of the joined portion between the fixing portion 2 and the housing 8 can be secured, deterioration such as galvanic corrosion can be reduced, and the image pickup device 100 thus has improved reliability.

The fixing portion 2 and the housing 8 are formed from the same metal material. More specifically, when the fixing portion 2 is formed from aluminum (for example, A5052), the housing 8 is also formed from aluminum (for example, A5052). In this structure, when the fixing portion 2 and the housing 8 are to be welded, components formed from the same metal are welded, and the welding is thus facilitated.

The fixing portion 2 and the housing 8 may be formed from different metals that can be welded together. For example, the fixing portion 2 and the housing 8 may be formed from a combination of different metals described below. Examples include a combination of aluminum (for example, A5052) and stainless steel (for example, SUS304, SUS420, or SUS440), a combination of aluminum and brass, and a combination of brass and stainless steel. When the fixing portion 2 and the housing 8 are formed from different metals, preferably, the housing 8 is formed from a metal material having a higher density than that of the fixing portion 2. This structure can further increase the total mass of the fixing portion 2 and the housing 8, further improve vibration confinement, and further reduce leakage of vibrations from the vibrator 3.

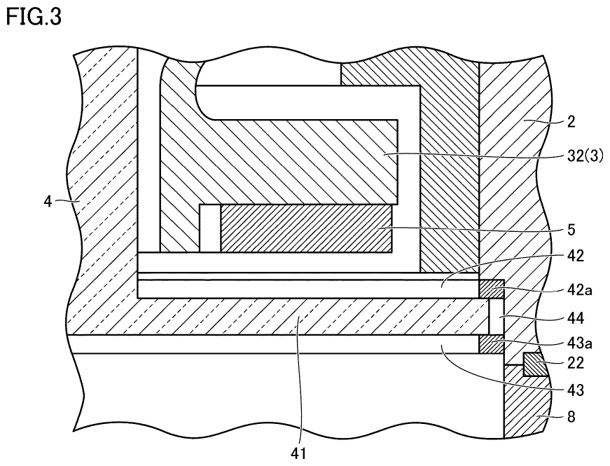

The welding portion 22 between the fixing portion 2 and the housing 8 is positioned at a location where the holding member 41 in the inner-layer lens 4 is fixed to the fixing portion 2. When heat applied during welding at the welding portion 22 is transmitted to the inner-layer lens 4 and the holding member 41, the heat may cause strain in the inner-layer lens 4 or affect the alignment between the inner-layer lens 4 and the outermost-layer lens 1. To address this issue, a structure that is less likely to transmit heat applied during welding to the inner-layer lens 4 and the holding member 41 is preferable. For example, FIG. 3 is a diagram describing an example of a connection between the holding member 41 of the inner-layer lens 4 and the fixing portion 2.

As illustrated in FIG. 3, instead of being directly attached to the fixing portion 2, the holding member 41 of the inner-layer lens 4 is attached to the fixing portion 2 by fasteners 42a and 43a disposed at end portions of buffer layers 42 and 43 disposed on the holding member 41. In addition, a gap 44 is provided between the fixing portion 2 and the end portion of the holding member 41 of the inner-layer lens 4 to allow the holding member 41 of the inner-layer lens 4 to be attached to the fixing portion 2 by the fasteners 42a and 43a. When less heat is applied during welding, the end portion of the holding member 41 of the inner-layer lens 4 may be directly attached to the fixing portion 2 without providing the gap 44.

The holding member 41 includes the buffer layer 42 on a surface facing the vibrator 3, and the buffer layer 43 on a surface facing the housing 8. The fastener 42a is disposed at the end portion of the buffer layer 42, and the fastener 43a is disposed at the end portion of the buffer layer 43. The buffer layers 42 and 43 are formed from, for example, rubber or resin. When the buffer layers 42 and 43 are disposed on the holding member 41, leakage of vibrations from the vibrator 3 can be reduced, and damping of the vibrator 3 can be reduced. The buffer layers 42 and 43 are preferably formed from a material with lower thermal conductivity than that of the fixing portion 2. In this structure, the buffer layers 42 and 43 are less likely to transmit heat applied during welding to the inner-layer lens 4 and the holding member 41.

The fastener 42a and the fastener 43a are preferably formed from a material with lower thermal conductivity than that of the fixing portion 2. Thus, the fastener 42a and the fastener 43a are less likely to transmit heat applied during welding to the inner-layer lens 4 and the holding member 41. For example, the fastener 42a and the fastener 43a are formed from, for example, resin or ceramics. Although not illustrated, the fastener 42a and the fastener 43a are, for example, ring springs corresponding to a thread groove formed on an inner wall surface of the fixing portion 2. The fastener 42a and the fastener 43a hold the end portion of the holding member 41 therebetween to fix the position of the inner-layer lens 4 with respect to the fixing portion 2. The fastener 42a and the fastener 43a may be other than ring springs, and may be fixed to the fixing portion 2 with an adhesive.

The image pickup device 100 further includes a weight 21 (first weight) between the fixing portion 2 and the vibrator 3. The weight 21 may be formed from the same metal material as the fixing portion 2, but is preferably formed from a metal material with a higher density than that of the fixing portion 2. For example, when the fixing portion 2 is formed from aluminum (for example, A5052), the weight 21 is formed from stainless steel (for example, SUS304, SUS420, or SUS440). This structure can further increase the total mass of the fixing portion 2 and the weight 21, further improve vibration confinement, and further reduce leakage of vibrations from the vibrator 3.

### First Modification Example

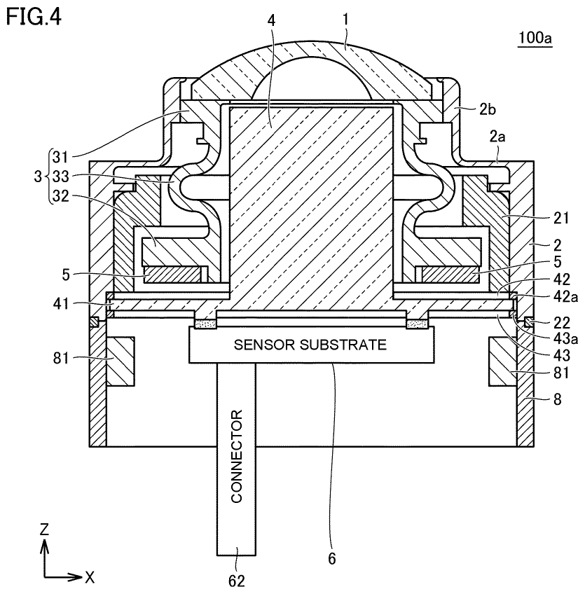

The image pickup device 100 illustrated in FIG. 2 includes the weight 21 between the fixing portion 2 and the vibrator 3, but a weight may be located at the housing 8. FIG. 4 is a cross-sectional view of an image pickup device 100a according to a first modification example. In the image pickup device 100a, the same components as those in the image pickup device 100 illustrated in FIG. 2 are denoted with the same reference signs without being described repeatedly.

The image pickup device 100a further includes a weight 81 (second weight) disposed at the housing 8. The weight 81 may be formed from the same metal material as the housing 8, but is preferably formed from a metal material with a higher density than that of the housing 8. For example, when the housing 8 is formed from aluminum (for example, A5052), the weight 81 is formed from stainless steel (for example, SUS304, SUS420, or SUS440). This structure can further increase the total mass of the housing 8 and the weight 81, further improve vibration confinement, and further reduce leakage of vibrations from the vibrator 3.

The weight 81 may be positioned at any position in the housing 8 at which the weight 81 can improve vibration confinement. To avoid an increase in size of the image pickup device 100a, preferably, the weight 81 is disposed inside the housing 8 instead of outside the housing 8.

### Second Modification Example

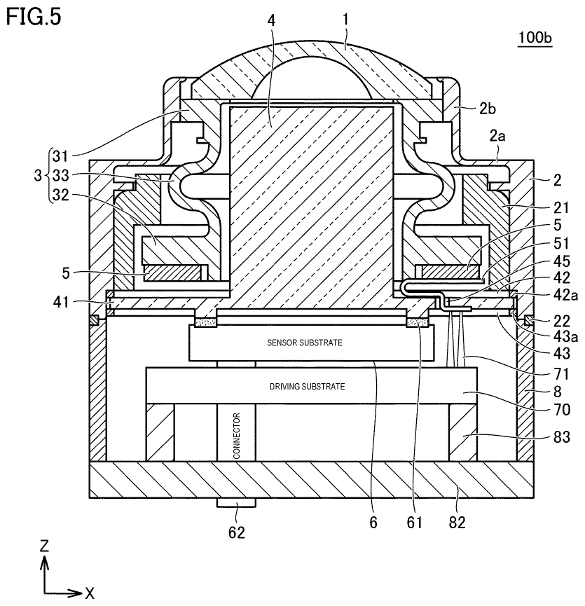

In the image pickup device 100 illustrated in FIG. 2, the sensor substrate 6 is disposed in the housing 8. However, the substrate disposed in the housing 8 is not limited to the sensor substrate 6, and may be another substrate. FIG. 5 is a cross-sectional view of an image pickup device 100b according to a second modification example. In the image pickup device 100b, the same components as those in the image pickup device 100 illustrated in FIG. 2 are denoted with the same reference signs without being described repeatedly.

As illustrated in FIG. 5, the image pickup device 100b includes a fixing portion 2 (first housing) that holds the outermost-layer lens 1, and a housing 8 (second housing) that is directly connected to the fixing portion 2 by welding. On the inner side of the fixing portion 2, a vibrator 3, an inner-layer lens 4, and a piezoelectric device 5 are disposed. On the inner side of the housing 8, a sensor substrate 6 (first substrate) on which an image pickup element (not illustrated) is mounted, and a driving substrate 70 (second substrate) on which a driving circuit for driving the piezoelectric device 5 is mounted, are disposed.

The driving substrate 70 is fixed to a lid 82, which fits onto the housing 8, by way of a support member 83. The driving substrate 70 includes a driving circuit that drives the piezoelectric device 5, for example, a semiconductor device such as a general-purpose IC or an ASIC. A flexible substrate 51 is disposed to electrically connect the piezoelectric device 5 and the driving substrate 70.

The flexible substrate 51 is electrically connected to the piezoelectric device 5, and is drawn out to the surface of the holding member 41 facing the sensor substrate 6 through a via 45 formed in the holding member 41. The via 45 is formed in the holding member 41 at a portion closer to the inner-layer lens 4. To electrically connect the flexible substrate 51 and the driving substrate 70, an elastic conductive pin 71 is disposed at the driving substrate 70. Thus, when the lid 82 that holds the driving substrate 70 is fitted to the housing 8, the conductive pin 71 comes into contact with an electrode of the flexible substrate 51, and the piezoelectric device 5 and the driving substrate 70 can be electrically connected to the flexible substrate 51.

Through the connector 62, the driving substrate 70 performs signal input or output with an external device or receives power from an external power supply. Thus, the driving substrate 70 can supply signals or power to the piezoelectric device 5 through the conductive pin 71 and the flexible substrate 51. When the flexible substrate 51 is fixed to the holding member 41, vibrations transmitted through the flexible substrate 51 to the sensor substrate 6 or the driving substrate 70 can be reduced, and noise caused by the vibrations can be reduced.

Although not illustrated, preferably, a buffer member (for example, rubber or resin) that damps vibrations is further interposed between the flexible substrate 51 and the holding member 41. Providing the buffer member can reduce noise from the flexible substrate 51. In addition, providing the buffer member can reduce frictional loss produced by vibrations between the flexible substrate 51 and the holding member 41, and reduce damping of vibrations resulting from fixing the flexible substrate 51 to the holding member 41.

In the image pickup device 100b, the elastic conductive pin 71 is used to electrically connect the flexible substrate 51 and the driving substrate 70, but the flexible substrate 51 and the driving substrate 70 may be electrically connected by another method, such as using a wire instead of the elastic conductive pin 71. In the image pickup device 100b, the driving substrate 70 is disposed inside the housing 8, but the driving substrate 70 may be disposed outside the housing 8. In that case, the flexible substrate 51 is routed from the housing 8, and is electrically connected to the driving substrate 70 outside the housing 8.

### Third Modification Example

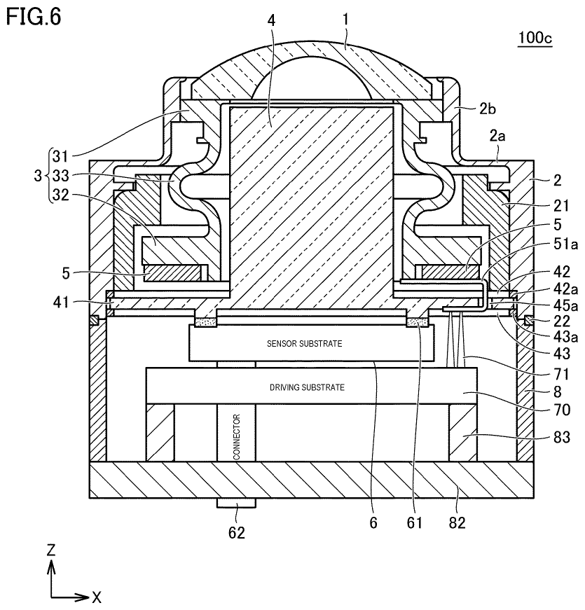

In the image pickup device 100b illustrated in FIG. 5, the via 45 that allows the flexible substrate 51 to pass therethrough is formed in the holding member 41 at a portion closer to the inner-layer lens 4. However, the via that allows the flexible substrate 51 to pass therethrough may be positioned at another position, instead of at a portion closer to the inner-layer lens 4. FIG. 6 is a cross-sectional view of an image pickup device 100c according to a third modification example. In the image pickup device 100c, the same components as those in the image pickup device 100 illustrated in FIG. 2 and the image pickup device 100b illustrated in FIG. 5 are denoted with the same reference signs without being described repeatedly.

A flexible substrate 51a is electrically connected to the piezoelectric device 5, and is drawn out to the surface of the holding member 41 facing the sensor substrate 6 through a via 45a formed in the holding member 41. The via 45a is positioned at a portion of the holding member 41 closer to the fixing portion 2. To electrically connect the flexible substrate 51a and the driving substrate 70, an elastic conductive pin 71 is disposed at the driving substrate 70. Thus, when the lid 82 that holds the driving substrate 70 is fitted to the housing 8, the conductive pin 71 comes into contact with an electrode of the flexible substrate 51a, and the piezoelectric device 5 and the driving substrate 70 can be electrically connected to the flexible substrate 51a.

### Other Modification Examples

In the vibrator 3 according to the above-described embodiment, the support portion 33 has an S-shaped cross section. However, the cross-sectional shape of the support portion is not limited to an S-shaped cross section, and may have any shape that does not cause stress concentration in the vibrator. The cross-sectional shape of the support portion 33 may be, for example, a shape formed by connecting multiple S-shaped curves, or a curved shape containing half of an S-shaped curve.

In the image pickup devices 100 and 100a to 100c according to the above-described embodiments, the sensor substrate 6 on which an image pickup element is mounted is fixed to the holding member 41 with an adhesive at a surface facing the holding member 41. Alternatively, in the image pickup devices 100 and 100a to 100c, the sensor substrate 6 may be fixed to the housing 8 or the lid 82.

In the image pickup devices 100, 100b, and 100c according to the above-described embodiments, the weight 21 is disposed at the fixing portion 2, and in the image pickup device 100a, the weight 21 is disposed at the fixing portion 2 and the weight 81 is disposed at the housing 8. Alternatively, the image pickup devices 100 and 100a to 100c may include neither the weight 21 nor the weight 81, or include at least one of the weight 21 or the weight 81.

The above-described image pickup devices 100 and 100a to 100c according to the embodiments may include, for example, a camera, a laser infrared radar (LiDAR), or a radar. Alternatively, multiple image pickup devices 100 and 100a to 100c may be arranged.

The above-described image pickup devices 100 and 100a to 100c according to the embodiments are not limited to an image pickup device installed on a vehicle, and may be similarly applicable to any image pickup device that includes an optical device and an image pickup element disposed with a light-transparent body in the direction of a field of view and that requires removal of foreign matter on the light-transparent body.

The embodiments disclosed herein are intended in all respects to be illustrative rather than restrictive. The scope of the present disclosure is defined by the scope of claims, not by the above description, and is intended to include the scope equivalent to the scope of the claims and all the changes within the scope.

### REFERENCE SIGNS LIST

1 outermost-layer lens
2 fixing portion
2a leaf spring
2b retainer
3 vibrator
4 inner-layer lens
5 piezoelectric device
6 sensor substrate
8 housing
21, 81 weight
22 welding portion
41 holding member
42, 43 buffer layer
42a, 43a fastener
44 gap
45, 45a via
51 flexible substrate
70 driving substrate
71 conductive pin
82 lid
83 support member
100, 100a to 100c image pickup device

1. An image pickup device, comprising:
a light-transparent body that transmits light with a predetermined wavelength;
a first tubular housing, and that holds the light-transparent body;
a vibrator that disposed in the first housing, and configured to vibrate the light-transparent body;
a piezoelectric device disposed at the vibrator, and configured to vibrate the vibrator; and
a second housing directly connected by welding to a first side of the first housing opposite a second side thereof at which the first housing holds the light-transparent body.

2. The image pickup device according to claim 1, wherein the first housing and the second housing comprise a same metal material.

3. The image pickup device according to claim 1, wherein the first housing comprises a first metal material the second housing comprises a second metal material, and the second metal material has a higher density than the first metal material.

4. The image pickup device according to claim 1, further comprising:
a lens disposed in the first housing so as to face the light-transparent body,
wherein the lens is attached to the first housing by a holding member,
wherein the holding member receives a first buffer layer on a surface facing the vibrator and a second buffer layer on a surface facing the second housing, and
wherein the holding member is attached to the first housing by a fastener at an end portion of the first buffer layer and the second buffer layer and defines a gap between an end portion of the holding member and the first housing.

5. The image pickup device according to claim 4, wherein the first buffer layer, the second buffer layer and the fastener comprise a material with a lower thermal conductivity than a material of the first housing.

6. The image pickup device according to claim 4, further comprising:
a first substrate fixed to the holding member with an adhesive at a surface facing the holding member; and
an image pickup element mounted on the first substrate and arranged in a direction of a field of view with the light-transparent body and the inner lens.

7. The image pickup device according to claim 6, further comprising a flexible substrate electrically connected to the piezoelectric device, drawn out to a surface of the holding member, and facing the first substrate through a via in the holding member.

8. The image pickup device according to claim 7, further comprising:
a second substrate in the second housing and electrically connected to the flexible substrate; and
a driving circuit mounted on the second substrate and configured to drive the piezoelectric device.

9. The image pickup device according to claim 1, wherein the first housing includes a first weight comprising a material with a higher density than a material of the first housing.

10. The image pickup device according to claim 9, wherein the second housing includes a second weight comprising a material with a higher density than a material of the second housing.

11. The image pickup device according to claim 9, wherein the second housing includes a second weight comprising a material with a higher density than a material of the second housing.

12. The image pickup device according to claim 1, wherein the vibrator has a tubular body and includes a first portion in contact with the light-transparent body, a second portion at which the piezoelectric device is disposed, and a third portion connecting the first portion and the second portion.

13. The image pickup device according to claim 12, wherein the third portion has an S-shaped cross section.

14. The image pickup device according to claim 12, wherein the second portion has a larger thickness than the first portion and the third portion.

15. The image pickup device according to claim 1, further comprising a weight disposed at the first housing or the second housing, wherein the weight comprises a material having a higher density than a material of the housing at which the weight is disposed.

16. The image pickup device according to claim 15, wherein the weight is inside the second housing.

17. An image pickup device, comprising:
a light-transparent body configured to transmit light with a predetermined wavelength;
a tubular first housing configured to hold the light-transparent body;
a vibrator disposed in the first housing and configured to vibrate the light-transparent body;
a piezoelectric device disposed at the vibrator and configured to vibrate the vibrator;
a lens disposed in the first housing and facing the light-transparent body;
a holding member configured to hold the inner lens;
a buffer layer on the holding member, wherein the buffer layer comprises a material having a lower thermal conductivity than a material of the first housing;
a fastener disposed at an end portion of the buffer layer and configured to attach the holding member to the first housing; and
a second housing directly connected by welding to a side of the first housing opposite a side at which the first housing holds the light-transparent body.

18. The image pickup device according to claim 17, wherein a gap is defined between an end portion of the holding member and the first housing.

19. The image pickup device according to claim 17, further comprising:
a flexible substrate electrically connected to the piezoelectric device,
wherein the flexible substrate extends through a via in the holding member.
